(19) United States
(12) Patent Application Publication
(10) Pub. No.: US 2004/0094903 A1
(43) Pub. Date: May 20, 2004

(54) Self-lubricating sealing ring

(76) Inventor: Bruce Sutherland, Kitchener (CA)

Correspondence Address: Arne I. Fors, Gowling Lafleur Henderson LLP, Suite 4900, Commerce Court West, Toronto, ON, M5L 1J3, CA

(21) Appl. No.: 10/298,660

(22) Filed: Nov. 19, 2002

(51) Int. Cl. F16L 17/06

(52) U.S. Cl. 277/609

(57) ABSTRACT

A sealing ring for fitting between and sealing an annular space between a spigot end of a length of pipe and a socket end of another length of pipe which are slid into each other to form a pipe joint. The sealing ring comprises an annular main body having a first surface for engaging the spigot end and a second surface for engaging the socket end during the formation of the pipe joint. A thin flexible membrane of a thickness of 0.045 inches or less is attached to the second surface about the circumference of the annular main body defining an annular cavity. The flexible membrane is of a greater dimension than the length of the second surface in the general direction of pipe movement. A lubricant is disposed in the annular cavity between the second surface and the thin flexible membrane whereby, when the spigot end and the socket end are slid into each other to form a pipe joint, the thin flexible membrane slides relative to the second surface without rupturing.

### FIELD OF THE INVENTION

This invention relates to sealing devices for pipe joints and, more particularly, relates to a self-lubricating sealing ring for a pipe joint.

### BACKGROUND OF THE INVENTION

Sealing rings are commonly used to seal pipe joints such as a socket and spigot joints in a pipeline. Lubricants such as a soap and water solution can be manually applied to the sealing rings to reduce the friction forces during the joining of two pipes. This is time consuming, messy, and sometimes dangerous work.

Self-lubricating sealing rings have been developed to avoid the manual labor involved in applying lubricant to a sealing ring and to expedite the process of joining two pipes.

U.S. Pat. No. 5,143,381 that issued Sep. 1, 1992 to Temple, discloses a sealing ring that has a closed chamber storing a lubricant such as grease. The sealing ring is placed upon the spigot end of a first pipe. The socket end of a second pipe engages the closed chamber and rolls back a flap formed in the sealing ring to open an annular slit thereby exposing a lubricant contained therein. In that the flap must be displaced onto the outer periphery of the ring, the thickness of the flap causes an undesirable radial pressure on the bell-shaped end of the second pipe.

U.S. Pat. No. 4,934,716 that issued Jun. 19, 1990 to Nordin et al. and U.S. Pat. No. 4,946,175 that issued Aug. 7, 1990 to Nordin et al. show a sealing ring having a membrane attached to a substantially triangular body. The base of the triangular body of the sealing ring is placed on the spigot end of a first pipe. When the socket end of a second pipe is fitted onto the spigot end of the first pipe, it comes into contact with the membrane and slides along the membrane. At the same time, the membrane slides upon the triangular body. There is little frictional resistance between the membrane and the sealing ring due to the presence of a lubricant disposed therebetween. The membrane extends beyond the vertex of the triangular body when the seal is effected, necessitating the presence of an annular space to receive the thickness of the membrane doubled upon itself.

U.S. Pat. No. 5,599,028 that issued Feb. 4, 1997 to Neumann et al. discloses attaching to the spigot end of a first pipe, a sealing ring with a substantially wedge shaped main body that has a rearward reception space for a variety of attachments portions. An attachment portion is comprised of a retainer element and a sliding jacket. The sliding jacket can be designed as a lubricant filled hose. In the first main embodiment, the retainer element is inserted into the main body reception space and the sliding jacket is positioned on the top of the main body for engagement with the socket end of the second pipe. The sealing function can be controlled by varying the dimensions and material hardness of the attachment portions.

U.S. Pat. No. 5,626,349 that issued May 6, 1997 to Sutherland et al discloses a sealing ring attached to the socket end of a first pipe and a rupturable membrane attached to the sealing ring surface that engages a bell-shaped end of a second pipe. The sealing ring surface and membrane define a cavity with lubricant disposed within. When the spigot end and the bell-shaped end are slid into each other to form a pipe joint, the membrane is ruptured and the lubricant released. The main body portion of the sealing ring is compressively deformed to seal the joint between the two pipes, which can cause undesired radial pressure on the bell-shaped end of the second pipe.

Sealing rings are usually comprised of rubber and extrusion is the most common method of forming rubber sealing rings. Since the membrane extends beyond the vertex of the body of the sealing ring, when using sealing rings produced through extrusion such as those disclosed in U.S. Pat. No. 4,934,716 and U.S. Pat. No. 5,599,028, it affects the fitting of the joint. These products require the socket and spigot ends of two adjoining pipes to be machined to provide a wider joint than normal to allow for usage of these sealing rings.

### SUMMARY OF THE INVENTION

The disadvantages of the prior art may be overcome by providing a sealing ring having a thin flexible membrane for encapsulating a lubricant whereby the sealing ring can affect a seal between the pipes without the joints of the pipes requiring machining. More particularly, the sealing ring of the invention contains a lubricant covered by a thin flexible membrane formed on an annular body whereby when connecting pipe joint members are slid into each other to form a pipe joint, the membrane is engaged by the socket end pipe and slides relative to the surface of the annular body, reducing the friction forces on the sealing ring during the joining of the pipes.

In its broad aspect, the sealing ring of the present invention for fitting between and sealing an annular space between connecting pipe joint members which are slid into each other to form a pipe joint comprises an annular main body and a thin flexible membrane, preferably having a thickness of 0.045 inches or less, containing a lubricant, attached thereto. The annular main body has a first surface engaging one of the pipe joint members and a second surface for engaging the other pipe joint member during the formation of the pipe joint. The membrane is attached at its opposite ends to corresponding opposite ends of the second surface and is of a greater dimension than the length of the second surface in the general direction of pipe movement, whereby, when the pipe joint members are slid into each other to form a pipe joint, the lubricant disposed circumferentially on the sealing ring on the second surface within the membrane allows for the membrane to slide relative to the second surface without rupturing.

In a preferred embodiment, the sealing ring is for fitting between and sealing a space between a sealing surface of a spigot end of a length of pipe and a sealing surface on a socket end of another length of pipe that are slid into each other to form a pipe joint.

### BRIEF DESCRIPTION OF THE DRAWINGS

The present invention will now be described in detail with reference to the accompanying drawings, in which:

FIG. 1 is a fragmentary cross-sectional elevational view of the sealing ring of the present invention positioned on a spigot end of a pipe; and

FIG. 2 is a fragmentary cross-sectional elevational view of the sealing ring showing the spigot end of the first pipe installed within the socket end of the second pipe.

### DESCRIPTION OF THE PREFERRED EMBODIMENTS

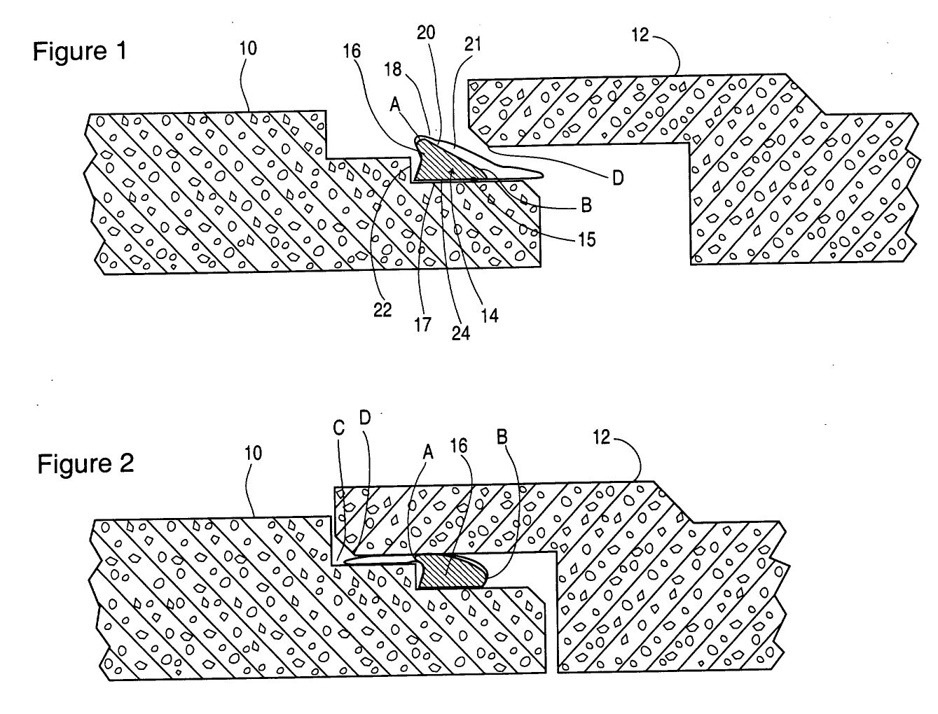

Referring first to FIG. 1, two coaxial concrete pipes are shown having mating spigot end 10 and socket end 12. The seal between the pipes is to be effected by the sealing ring 14. The base 15 of the sealing ring 14 of the invention abuts shoulder 22 of spigot end 10 of the first pipe. The sealing ring 14 consists of an annular main body portion 16 having a substantially triangular shape with a first surface 17 engaging spigot surface 24, an inclined second surface 20 and a thin flexible membrane 18 which is connected at one end about the circumference of the sealing ring at the vertex A of the main body portion 16 and at the opposite end to the other end of inclined second surface 20 at corner B of the main body portion 16.

The main body portion 16 and thin flexible membrane 18 are preferably constructed from an elastomeric material such as vulcanized rubber. Sealing ring 14 can be manufactured by co-extruding the profile of the main body portion 16 and membrane 18, cutting the extrusion to length, and joining its ends. Ring 14 can be co-extruded such that membrane 18 is joined to main body portion 16 at either point of attachment vertex A or main body point of attachment corner B, and the unattached end is attached later to the other point of attachment by various means such as pressure-heat sealing or adhesive bonding. It is preferred that ring 14 is co-extruded with thin flexible membrane 18 attached at opposite ends to main body portion 16 at both points of attachment A and B and that the thin flexible membrane be of a thickness of 0.045 inches or less.

The attachment of the membrane 18 to the inclined second surface 20 of the main body portion 16 of the sealing ring 14 creates a pocket 21. A lubricant is injected into pocket 21 to completely and circumferentially fills it.

Membrane 18 is of a dimension greater than the length of inclined second surface 20 in the direction between points of attachment A and B, i.e. has a length of at least the distance of A to B plus double the distance of inner bevel edge D to A of an assembled pipe joint, such that thin flexible membrane 18 can be slideably displaced without rupturing. And furthermore, before assembly the segment of said thin flexible member 18 that is between points of attachment A and B is not tight or taut such that thin flexible membrane 18 and contained lubricant in pocket 21 form a loose bag-like structure.

When joining the two pipes, the socket end 12 of the second pipe comes into contact with the membrane 18. As the axial alignment of the pipes may not be exact, the bevel edge D of socket end 12 may come into contact with the membrane 18 at various places on inclined surface 20.

The contact of the socket end 12 with sealing ring 14 engages membrane 18 and displaces it to slide relative to annular main body 16. The bag-like structure formed of thin flexible membrane 18 and lubricant filled pocket 21 can be extended for the full distance the pipe ends slide relative to each other during formation of the pipe joint without rupturing.

FIG. 2 shows the final sealed position of spigot end 10 and socket end 12. The main body portion 16 of sealing ring 14 is compressively deformed to seal the joint between the two pipes. Membrane 18 is displaced and in large part is present in cavity C. As is evident from FIG. 2, when the pipes are joined, cavity C is minute. The thinness of the membrane 18 does not cause problems with the fitting of the joint within cavity C. If a significant quantity of the material of the membrane accumulated in cavity C after joining spigot end 10 and socket end 12, such as would be inherent in the prior art devices, it could cause deflection of the pipes. Such pipe deflection would cause strain on the joint. Also, if relatively thick membranes were utilized for the concrete pipe joint of FIG. 2, there would not be sufficient space to allow for the membrane to be displaced into cavity C.

It will be understood that modifications can be made in the embodiments of the invention described herein without departing from the scope and purview of the invention as defined by the appended claims.

We claim:

1. A sealing ring for fitting between and sealing an annular space between connecting pipe joint members which are slid into each other to an assembled position during assembly to form a pipe joint, said sealing ring comprising:
an annular main body having a substantially triangular shape having a vertex and a base, said base adapted to be in substantially undisplaceable engagement with the first of the pipe joint members, and said body having an inclined surface between said vertex and said base defining a corner with said base, for engaging the second pipe joint member during the formation of the pipe joint;
a thin flexible membrane attached to said inclined surface at points of attachment proximate said vertex and proximate said corner about the circumference of the annular main body defining an annular cavity, said cavity defined between said membrane and said inclined surface;
said membrane having a dimension greater than that between said points of attachment to said inclined surface of said annular main body, such that said flexible membrane can be slideably displaced without rupturing; and
a lubricant disposed in said cavity about the circumference of the annular main body such that when said pipe joint members are slid into each other to form a pipe joint, said flexible membrane is engaged and displaced by the second pipe member and that said membrane slides relative to the annular main body without rupturing.

2. A sealing ring for fitting between and sealing an annular space between connecting pipe joint members which are slid into each other to form a pipe joint as claimed in claim 1, wherein one of said pipe joint members comprises a spigot end of a pipe and the other pipe joint member comprises a socket end of another length of pipe.

3. A sealing ring for fitting between and sealing an annular space between connecting pipe joint members which are slid into each other to form a pipe joint as claimed in claim 2, wherein when said flexible membrane is engaged and displaced by the socket end of the second pipe member, the flexible membrane is of such thickness that it is displaced without deflection of the pipes.

4. A sealing ring for fitting between and sealing an annular space between connecting pipe joint members which are slid into each other to form a pipe joint as claimed in claim 3, wherein said annular main body and said thin flexible membrane are co-extruded such that the flexible membrane is made of the same material as the main body and the flexible membrane is attached to the main body by co-extrusion at either point of attachment or is attached by co-extrusion at both points of attachment.

5. A sealing ring for fitting between and sealing an annular space between connecting pipe joint members which are slid into each other to form a pipe joint as claimed in claim 3, wherein that before the pipe joint members are connected, the segment of said flexible member that is between said points of attachment is not tight or taught, and the thin flexible membrane and said lubricant disposed of in said cavity form a loose bag-like structure.

6. A sealing ring for fitting between and sealing an annular space between connecting pipe joint members which are slid into each other to form a pipe joint as claimed in claim 5, wherein said bag-like structure can be extended for the full distance the pipe ends slide relative to each other during formation of the pipe joint.
